(19) United States
(12) Patent Application Publication
(10) Pub. No.: US 2017/0068990 A1
(43) Pub. Date: Mar. 9, 2017

(54) Providing Sponsored Content Items to a User

(71) Applicant: Google Inc., Mountain View, CA (US)

(72) Inventors: Scott James Ogden, Redfern (AU); Nabil Naghdy, Lilyfield (AU)

(21) Appl. No.: 14/847,382

(22) Filed: Sep. 8, 2015

(51) Int. Cl. G06Q 30/02; H04W 4/02; H04W 4/20

(52) U.S. Cl. CPC G06Q 30/0261; H04W 4/206; H04W 4/02

(57) ABSTRACT

Systems and methods of providing content to a user are provided. In particular, contextual data associated with one or more locations within a region of interest can be analyzed in view of contextual data associated with a user to determine one or more points of interest that may be relevant to the user. One or more content items associated with the relevant points of interest can then be provided to the user. At least one of the one or more content items can be a sponsored content item provided by a content provider. The at least one sponsored content item can be provided to the user based at least in part on the relevance of the sponsored content item to the user. The at least one sponsored content item can be provided to the user based at least in part on a bid received as part of an auction.

### FIELD

The present disclosure is directed to providing sponsored content items to a user, and more particularly to providing sponsored content items to a user based at least in part on contextual data associated with the user.

### BACKGROUND

Many different techniques exist for attempting to provide users with relevant information relating to points of interest within a geographic area. For instance, a user may desire to learn about various entertainment and/or restaurant options within the geographic area. Point of interest aggregators, such as guidebooks or other point of interest aggregators, exist to provide users with an overview of interesting, noteworthy, or otherwise useful places or locations within different geographic areas. In this manner, a point of interest aggregator may assist a user with finding businesses or other points of interest that have physical locations within a geographic area, such as restaurants, stores, parks, etc.

Advertisement content relating to user requested content may be provided to a user to help monetize content being provided to users, and to provide users with offers and promotions relating to user activity. A content provider (e.g. advertiser) may wish to inform users within a geographic area of the content provider's goods or services. In particular, advertisers may wish to advertise their goods or services in a point of interest aggregator to users who are looking for places to visit within the geographic area.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of providing content to a user within a point of interest aggregator. The method includes providing for display, by one or more computing devices, a user interface associated with a point of interest aggregator. The point of interest aggregator is configured to provide to a user information associated with a region of interest. The method further includes receiving, by the one or more computing devices, first contextual data associated with a region of interest. The first contextual data is associated with one or more locations within the region of interest. The method further includes identifying, by the one or more computing devices, a plurality of points of interests within the region of interest based at least in part on the first contextual data. The method further includes receiving, by the one or more computing devices, second contextual data associated with user. The method further includes identifying, by the one or more computing devices, one or more sponsored content items. Each sponsored content item provides information associated with a relevant point of interest. The method further includes providing, by the one or more computing devices, at least one of the one or more identified sponsored content items within the user interface associated with the point of interest aggregator.

Other example aspects of the present disclosure are directed to systems, apparatus, tangible, non-transitory computer-readable media, user interfaces, memory devices, and electronic devices for determining device location (e.g. semantic place name) and/or analyzing location reports.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example point of interest aggregator user interface according to example embodiments of the present disclosure;

FIG. 2 depicts an overview of an example system for providing sponsored content to users according to example embodiments of the present disclosure;

FIG. 3 depicts a flow diagram of an example method of providing sponsored content to users according to example embodiments of the present disclosure;

FIG. 4 depicts a flow diagram of an example method of providing sponsored content to users based at least in part on an auction according to example embodiments of the present disclosure; and

FIG. 5 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example embodiments of the present disclosure are directed to providing content to a user. In particular, one or more content items can be identified based at least in part on contextual data associated with a region of interest and/or contextual data associated with a user. The one or more content items can be sponsored content items (e.g. advertisements). At least one of the identified content items can then be provided to the user. For instance, at least one content item can be provided for display by a user device in a user interface associated with a point of interest aggregator.

As used herein, a point of interest aggregator can be a website, web application, or other computer program that provides information to a user related to a plurality of relevant points of interest in a region of interest. For instance, such points of interest may include restaurants, bars, pubs, cafes, museums, art galleries, parks, shopping destinations, book stores, movie theaters, sports venues, concert venues, historical landmarks, hotels, and/or various other suitable points of interest. The information related to the points of interest may include location information, user feedback information (e.g. user reviews), operating hours, a menu, a schedule of events, photographs, etc. A point of interest aggregator may further divide various points of interests into one or more categories, such that a user can quickly and efficiently identify points of interest related to a desired activity. The point of interest aggregator may be implemented in conjunction with a mapping application or other geographic information system, for instance, implemented on a user device (e.g. smartphone, tablet, laptop, wearable computing device, or any other suitable computing device capable of being carried by a user while in operation), such that a user can identify points of interest proximate the user's current location or a desired location that the user is viewing or investigating. In this manner, a point of interest aggregator may be configured to provide content to the user without the user having to search (e.g. provide a search query to a search engine) for a particular item.

According to example aspects of the present disclosure, one or more sponsored content items can be provided to a user by a point of interest aggregator. In particular, the one or more sponsored content items can be identified based at least in part on contextual data associated with a region of interest. The region of interest can correspond, for instance, to a current location of the user. The current location can be determined from a user input, or can be determined based on GPS, IP address, cell triangulation, proximity to Wi-Fi access points, proximity to beacon devices, or other techniques. The contextual data associated with the region of interest can include data relating to one or more locations within the region of interest. For instance, such contextual data can include data relating to activities that can be performed at the locations, user reviews associated with the locations, social media activity associated with the locations, proximity to the current location of the user, weather proximate the points of interest, etc. In further embodiments, the contextual data associated with the region of interest can include temporal data (e.g. hour, day, season, etc.).

The contextual data associated with the region of interest can be analyzed to identify one or more points of interest within the region of interest. A point of interest can be a popular, prominent, or otherwise notable location within the region of interest. In example embodiments, different locations can be identified as a point of interest in different contexts. A location may be of varying interest to a user or a group of users in different contexts. For instance, a location corresponding to a beach may be of interest during warm, sunny days, but may not be of interest during the winter season, at night, or in rainy weather. In this manner, locations in the region of interest can be analyzed in view of the contextual data to determine or identify one or more points of interest.

The one or more sponsored content items can further be identified based at least in part on contextual data associated with a user. The contextual data associated with the user may include temporal data (e.g. a current hour, day, season, etc.), location data, and/or weather data. The contextual data associated with the user may further include, for instance, data associated with one or more interests of the user. For instance, the contextual data can indicate that the user enjoys Italian food, or is a baseball fan. Such contextual data can be expressly input by the user, or can be determined automatically. For instance, the contextual data can be determined at least in part from a user profile associated with a social media account. As another example, upon obtaining express user consent, contextual data can be determined from one or more of the user's previous actions. For instance, it can be determined that the user is a baseball fan if the user frequently attends baseball games, or frequently visits websites relating to baseball.

In example embodiments, the contextual data associated with the region of interest can be analyzed in view of the contextual data associated with the user to identify one or more points of interest that may be relevant or of interest to the user. For instance, the one or more points of interest identified using the contextual data associated with the region of interest can be ranked or otherwise filtered based at least in part on the contextual data associated with the user. In this manner the one or more points of interest can be ranked based at least in part on the user's interests. The ranking may further take into account the temporal data associated with the user and/or the current weather data associated with the user and/or the region of interest and/or other factors.

As indicated above, the identified points of interest can have one or more associated sponsored content items (e.g. advertisements). For instance, a point of interest corresponding to a steakhouse may have an associated sponsored content item providing information relating to the steakhouse. At least one of the one or more sponsored content items can be provided to the user by the point of interest aggregator. In example embodiments, the one or more sponsored content items can have associated bids provided by a content provider. The bid can be indicative of an amount of money that the content provider is willing to pay for the content item to be provided to the user. For instance, the bid may be indicative of an amount of money to be paid per interaction with the content item by a user. In this regard, an auction can be conducted to determine one or more winning bids, and the sponsored content item can be provided to the user when it represents one of the winning bids.

The auction can further take into account the relevance of the sponsored content items to the user in providing a sponsored content item to the user. For instance, the rank of the point of interest associated with the sponsored content item can be used in determining one or more winning bids. In this manner, a combined score may be determined indicative of the bid provided by the content provider and the relevance of the sponsored content item to the user. One or more sponsored content items may be provided to the user (e.g. displayed in a user interface associated with the point of interest aggregator) based at least in part on the combined score. In alternative embodiments, the auction can further still take into account the past performance of the sponsored content items in providing a sponsored content item to the user. For instance, the past performance of a sponsored content item can be determined based at least in part on a previous click-through rate of the sponsored content item.

In some embodiments, in order to obtain the benefits of the techniques described herein, a user may be required to allow the collection and analysis of location information associated with a user or device. For example, in some embodiments, users may be provided with an opportunity to control whether programs or features collect such information. If the user does not allow collection and use of such signals, then the user may not receive the benefits of the techniques described herein (e.g. may not be provided information associated with semantic place name). The user may also be provided with tools to revoke or modify consent. In addition, certain information or data can be treated in one or more ways before it is stored or used, so that personally identifiable information is removed. For example, embodiments of the disclosed technology may be configured to enhance user privacy by removing identifiers for mobile devices or users. In some instances, device and/or user identifiers can be replaced with a lossy or aggregate device indicator which might conflate a large number of devices or users into a single identifier.

### Example Point of Interest Aggregators

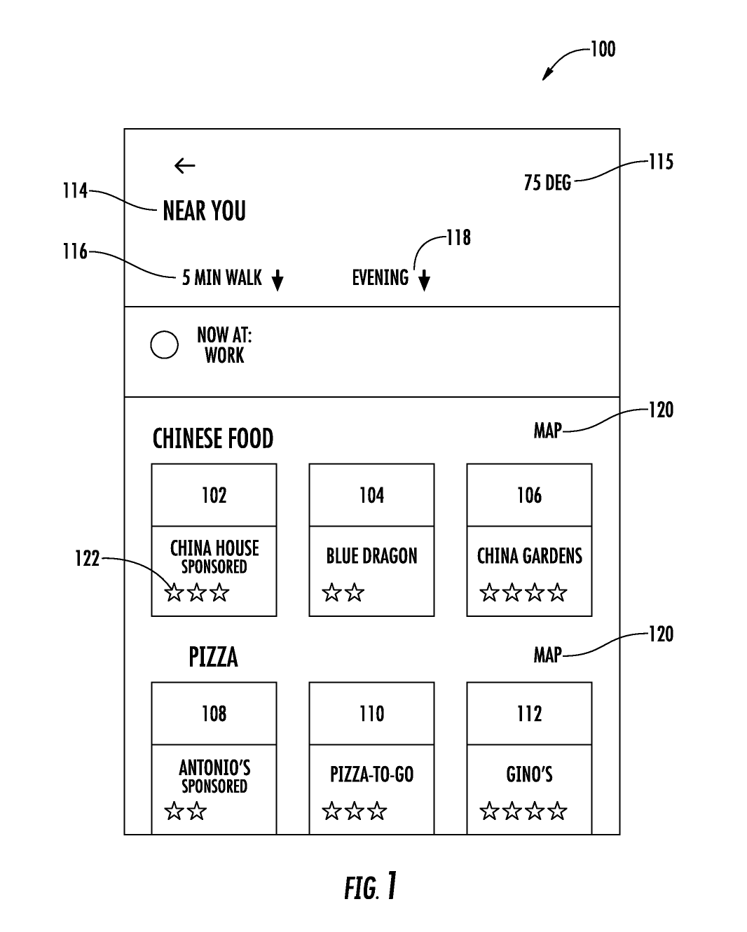

With reference now to the figures, example embodiments of the present disclosure will be discussed in further detail. FIG. 1 depicts an example user interface 100 for a point of interest aggregator. As depicted, user interface 100 can display information regarding points of interest within a region of interest. For instance, user interface 100 depicts points of interest 102, 104, and 106 associated with a “Chinese Food” category, and points of interest 108, 110, and 112 associated with a “Pizza” category. Points of interest 102-112 can be associated with a region of interest 114. For instance, region of interest 114 corresponds to a geographic area proximate a user (e.g. “Near You”). It will be appreciated that various other regions of interest can be used corresponding to various other geographic areas. For instance, the region of interest can correspond to a region of interest that a viewer is viewing or investigating within a mapping application. In embodiments wherein the region of interest corresponds to a current location of a user, the current location can be input by the user, or determined automatically using GPS, IP address, cell triangulation, proximity to Wi-Fi access points, proximity to beacon devices, or other suitable location determination techniques. The current location can be a semantic location (e.g. “Now at: Work”), or can be raw location data, such as latitude/longitude coordinates.

User interface 100 further includes a radius selector 116. Radius selector 116 can allow a user to specify an area within the region of interest for which points of interest should be displayed. For instance, radius selector 116 specifies an area corresponding to approximately a five minute walk for the user. In this manner, user interface 100 can display one or more points of interest that are located within a distance corresponding to a five minute walk for the user. User interface 100 further includes a time selector 118. Time selector 118 can allow a user to specify a time (e.g. “Evening”) associated with the displayed points of interest. In this manner, user interface 100 can display points of interest that may be notable or popular at or around the selected time. For instance, when time selector 118 specifies “Evening,” use interface 100 may not display, for instance, information relating to restaurants that are only open for lunch. As another example, when time selector 118 specifies “Afternoon,” user interface 100 may not display bars or clubs that are primarily associated with late night entertainment. User interface 100 may further include a weather indicator 115 configured to display a current temperature and/or current weather pattern proximate the region of interest.

User interface 100 can further include a mapping application or other geographic information system. In this manner, user interface 100 can display points of interest 102-112 in a list or grid implementation (as depicted), or in association with the mapping application. For instance, information relating to points of interest 102-112 can be overlaid on top of a map interface corresponding to the region of interest. In particular, user interface 100 can further include view selectors 120. View selectors 120 can allow a user to select the view from which the points of interest 102-112 are displayed (e.g. map view, list view, grid view, etc.). In example embodiments, each point of interest category (e.g. “Chinese Food,” Pizza,” etc.) can have an associated view selector. In this manner, when a map view for “Chinese Food” is specified, user interface 100 can display information relating to points of interest 102-106 overlaid over a graphical representation of the region of interest in a mapping application.

User interface 100 can further display information associated with points of interest 102-112. For instance, each point of interest 102-112 can have a rating 122 or other indicator of the quality of the point of interest. Ratings 122 may be a rating relative to a predetermined scale, (e.g. 4 out of 5 stars, 85 out of 100, etc.) and may be based at least in part on customer feedback or reviews associated with the point of interest. It will be appreciated that various other information associated with points of interest 102-112 can be displayed.

Points of interest 102-112 may be further selectable, such that when the user selects a point of interest 102-112, user interface is configured to display additional information associated with the point of interest. For instance, responsive to receiving a user input selecting point of interest 104, user interface 100 may be configured to display additional information associated with point of interest 104. Such information can include location information, (e.g. address, map data, proximity to the user, navigational directions to the point of interest, etc.), operating hours, menus, a link to a website, an option to dial a phone number associated with point of interest 104, photographs, videos, an option to make reservations, user reviews, or other suitable information.

As depicted, user interface 100 can display one or more sponsored points of interests (e.g. points of interest 102 and 108). As will be described in more detail, sponsored points of interest 102, 108 can be displayed responsive to a sponsored content auction. For instance, one or more content providers may submit bids to provide a sponsored content item to a user. One or more sponsored content items may be provided for display to the user based at least in part on the submitted bids and a relevance of the sponsored content item to the user.

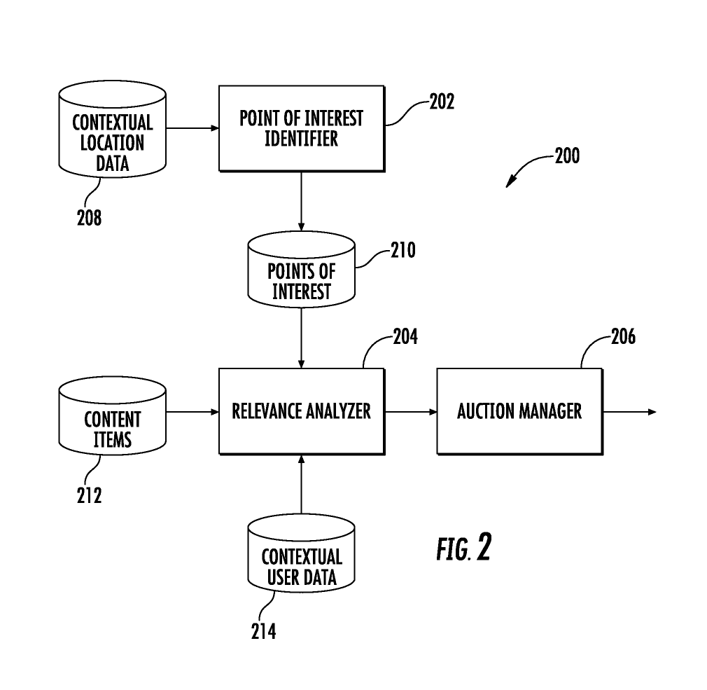

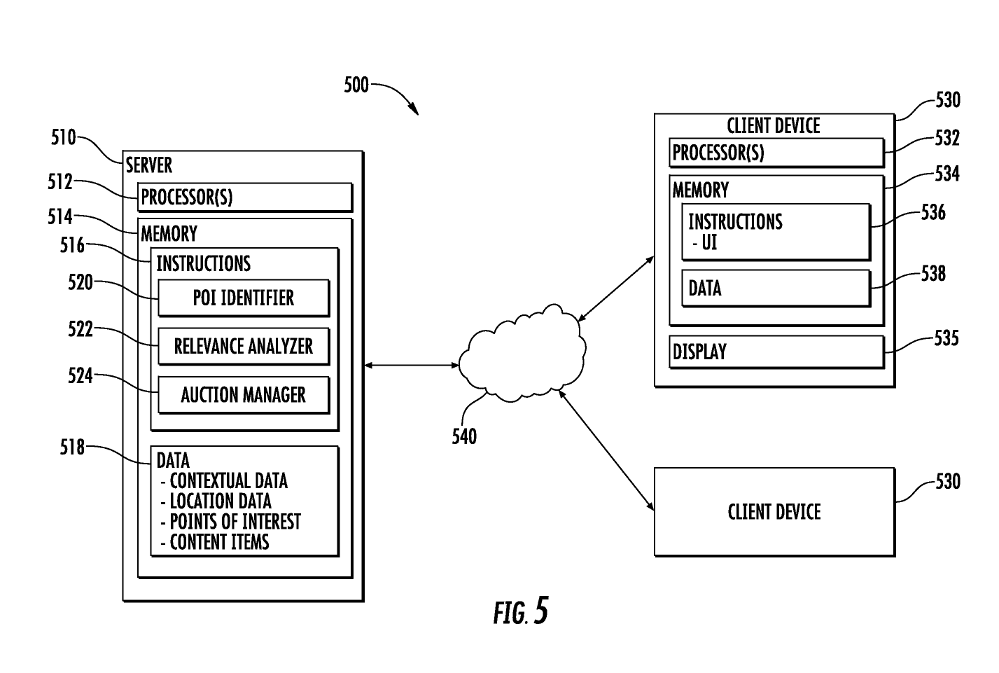

For instance, FIG. 2 depicts an overview of an example system 200 for providing sponsored content items to a user in a point of interest aggregator. System 200 includes a point of interest identifier 202, a relevance analyzer 204, and an auction manager 206. The point of interest identifier 202, the relevance analyzer 204, and the auction manager 206 can be implemented by one or more of the computing devices in FIG. 5.

Point of interest identifier 202 can be configured to access contextual location data 208 and to determine one or more points of interest 210 based at least in part on the accessed contextual location data 208. Relevance analyzer 204 can be configured to receive point of interest data 210, content items 212, and contextual user data 214. Relevance analyzer 204 can then be configured to identify one or more relevant points of interest and/or relevant content items associated with point of interest data 210. Auction manager 206 can be configured to receive one or more bids from one or more content providers. The one or more bids can be indicative of an amount of money the content providers are willing to pay for their content items to be displayed to one or more users. Auction manager 206 can then be configured to provide for display at least one of the one or more content items based at least in part on the received bids, and a content score associated with the content items. The content score can be indicative of the relevance of the content item to a user, the quality of the content item, and/or a previous performance of the content items.

It will be appreciated that point of interest identifier 202, relevance analyzer 204, and/or auction manager 206 may be implemented using computer logic to provide desired functionality. Thus, point of interest identifier 202, relevance analyzer 204, and/or auction manager 206 can be implemented in hardware, application specific circuits, firmware and/or software controlling a general purpose processor. In one embodiment, point of interest identifier 202, relevance analyzer 204, and/or auction manager 206 are program code files stored on the storage device, loaded into one or more memory devices and executed by one or more processors or can be provided from computer program products, for example computer executable instructions, that are stored in a tangible computer-readable storage medium such as RAM, ROM, flash memory, hard disk or optical or magnetic media. When software is used, any suitable programming language or platform can be used to implement the module.

As indicated, point of interest identifier 202 can receive, access, or otherwise obtain contextual location data 208. Contextual location data 208 can be data relating to one or more locations in a region of interest. For instance, such locations can include restaurants, pubs, bars, event venues, concert halls, museums, parks, hotels, shopping stores, grocery stores, historical landmarks and/or various other suitable locations. Contextual data 208 can include user reviews, location data (e.g. semantic location and/or raw location), operating hours, menus, the type of activities that can be performed at the location, the type of customers and/or visitors who frequent the location, weather data, temporal data, social media activity associated with the locations (e.g. “check-in” data), and/or various other suitable information. Point of interest identifier 202 can be configured to identify a number of points of interest 210 based at least in part on contextual location data 208. A point of interest can be a prominent, popular, or otherwise notable location within the region of interest. For instance, a point of interest can be a location within the region of interest that a user or group of users may be interested in learning more information about.

Points of interest 210 can then be provided to relevance analyzer 206. Relevance analyzer 206 can be configured to determine one or more points of interest that may be relevant to a user. In particular, relevance analyzer 206 can further receive contextual user data 214 associated with the user, and can analyze the received points of interest 210 in view of the contextual user data 214 to determine the relevant points of interest. Contextual user data 214 can include the user's present location (e.g. determined using a positioning system associated with a user device), temporal data (e.g. a current hour, day, season, etc.), and/or weather data. The contextual data associated with the user may further include, or otherwise be used to determine, data associated with one or more interests of the user determined, for instance, from a social media user profile associated with the user. For instance, contextual user data 214 may indicate that the user enjoys Chinese food based at least in part on the user's social media activity. In particular, if the user often “checks-in” to Chinese restaurants on social media, it can be determined that the user enjoys Chinese food.

In example embodiments, the user may expressly specify one or more user interests or other contextual data. For instance, the user may expressly specify that the user enjoys baseball, or that the user is interested in seeing results associated with a specified day or time. As another example, the user may expressly specify a location for which points of interest should be identified.

Relevance analyzer 206 can further be configured to respectively associate one or more content items 212 (e.g. sponsored content items) with at least a portion of the points of interest 210. For instance, a content item containing information relating to a point of interest can be associated with that point of interest. In example embodiments, relevance analyzer 206 can be configured to associate content items 212 with the points of interest determined to be relevant to the user. In such embodiments, for instance, once a point of interest is determined to be relevant to the user, relevance analyzer 206 can be configured to identify one or more content items and/or sponsored content items associated with the point of interest.

In example embodiments, at least one sponsored content item associated with a relevant point of interest can be provided to the user. In particular, the at least one sponsored content item can be provided for display by a point of interest aggregator, such as the point of interest aggregator depicted in FIG. 1. For instance, auction manager 208 can be configured to provide a sponsored content item to the user based at least in part on a received auction bid associated with the sponsored content item. In further embodiments, the relevance analyzer 206 and/or auction manager 208 may be configured to determine a quality score associated with the sponsored content item. The quality score may be a score, ranking and/or other metric indicative of the relevance of the sponsored content item to the user, the aesthetic quality of the sponsored content item, and/or a performance history of the sponsored content item. In this manner, provision of the at least one sponsored content item to the user can be determined based at least in part on the received auction bid associated with the sponsored content item and the determined quality score.

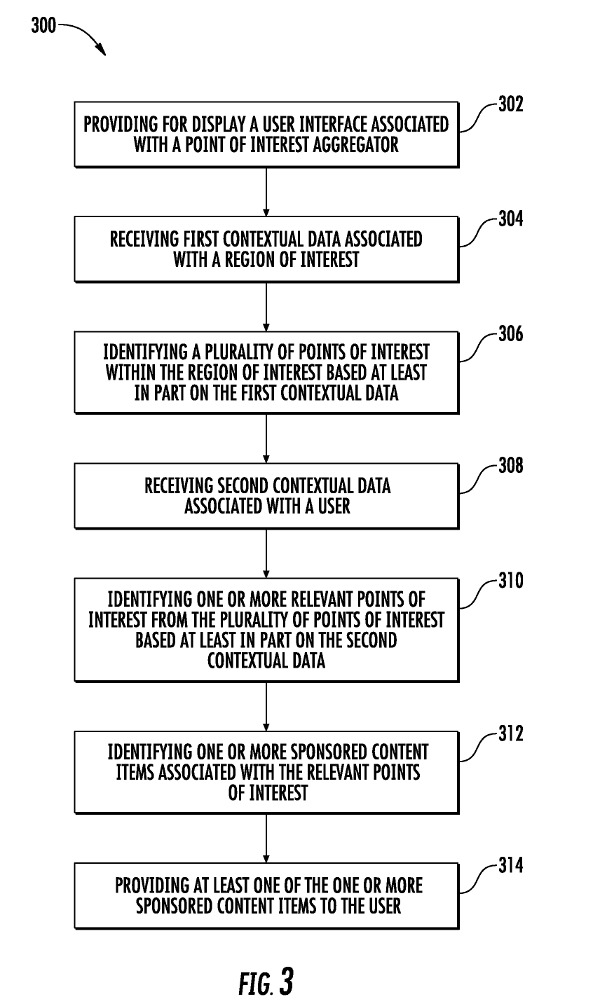

FIG. 3 depicts a flow diagram of an example method (300) of providing sponsored content items to a user. Method (300) can be implemented by one or more computing devices, such as one or more of the computing devices depicted in FIGS. 2 and 5. In particular implementations, method (300) can be implemented by the point of interest identifier 202, and/or the relevance analyzer 204 depicted in FIGS. 2 and 5. In addition, FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (302), method (300) can include providing for display, a user interface associated with a point of interest aggregator. In example embodiments, the user interface can correspond to user interface 100 of FIG. 1. At (304), method (300) can include receiving first contextual data associated with a region of interest. In example embodiments, the region of interest can be a geographic area corresponding to the current location of the user. In particular, the current location of the user can be determined by GPS, IP address, cell triangulation, proximity to Wi-Fi access points, proximity to beacon devices, or other techniques. In alternative embodiments, the region of interest can be a user selected geographic area. As indicated above, the first contextual data associated with the region of interest can include data relating to a plurality of locations within the region of interest. In addition, such first contextual data may include temporal data (e.g. time of the day, day of the week, season of the year, etc.), and/or weather data indicative of the current weather and/or a weather forecast associated with the region of interest.

At (306), method (300) can include identifying a plurality of points of interest within the region of interest based at least in part on the first contextual data. In particular, one or more locations within the region of interest can be determined to be points of interest based at least in part on the first contextual data. For instance, the contextual data associated with the locations within the region of interest can be analyzed to determine whether information associated with the locations is worth providing to a user in a point of interest aggregator. In this manner, the point of interest aggregator can identify points of interest to provide to a user an overview of options associated with one or more categories of locations within the region of interest.

At (308), method (300) can include receiving second contextual data associated with a user. The second contextual data associated with the user can include data relating to the user's interests and/or hobbies. Such interests and/or hobbies can be determined, for instance, from a user's prior search history, a user's social media activity, and/or other sources. In addition, the second contextual data can include data relating to a user's current context. For instance, the second contextual data may include temporal data and/or weather data associated with the user.

At (310), method (300) can include identifying one or more points of interest from the previously identified plurality of points of interest that may be relevant or of interest to the user. The one or more relevant points of interest may be identified based at least in part on the second contextual data associated with the user. In particular, the relevant points of interest may be identified by analyzing the plurality of points of interest in view of the second contextual data.

As indicated above, the relevant points of interest may be points of interest that correspond to an interest of the user. For instance, if it is determined that the user enjoys Chinese food, the relevant points of interest may include one or more Chinese restaurants. The relevant points of interest may further include points of interest that correspond to a current context associated with the user. For instance, if it is determined that the user is not located in his home town, the one or more relevant points of interest may include historical landmarks or other tourist attractions, such as museums or famous restaurants. As another example, if current weather data indicates that it is raining outside, the relevant points of interest may include only points of interest that include indoor aspects. As yet another example, if an approximate time of mid-afternoon is specified by the user, the relevant points of interest may include restaurants that serve lunch. In this manner, the relevant points of interest may not include restaurants that are only open for breakfast or dinner.

At (312), method (300) can include identifying one or more sponsored content items associated with the relevant points of interest. The sponsored content item may be an advertisement associated with the point of interest. In particular, the advertisement may be a digital advertisement that includes visual, audio and or textual aspects. The sponsored content items may be provided by a content provider associated with the point of interest.

At (314), method (300) can include providing at least one of the one or more sponsored content items to the user. For instance, the at least one sponsored content item can be provided within the user interface associated with the point of interest aggregator. In particular, provision of the at least one sponsored content item to the user can be determined based at least in part on the relevance of the sponsored content item to the user. In this manner, the relevant points of interest and/or sponsored content items may be ranked or otherwise scored based at least in part on relevance to the user, and provision of the at least one sponsored content item can be determined based at least in part on the ranking

In example embodiments, provision of the at least one sponsored content item can be further determined based at least in part on a performance history of the sponsored content item. In particular, provision of the at least one sponsored content item can depend on a previous click-through rate of the sponsored content item. As yet another example, provision of the at least one sponsored content item can be based at least in part on an aesthetic quality of the sponsored content item. The aesthetic quality can correspond to a user experience in viewing and/or hearing the sponsored content item.

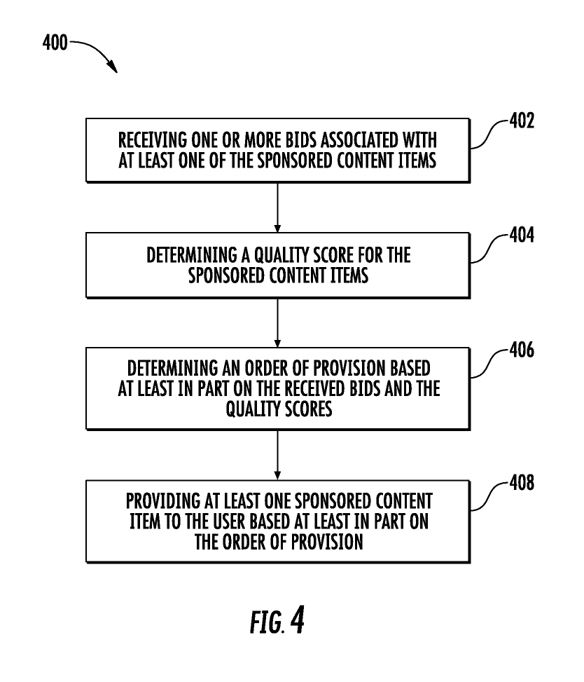

In example embodiments, provision of the sponsored content items may be determined at least in part on an auction wherein content providers submit bids to secure an advertising space. For instance, FIG. 4 depicts a flow diagram of an example method (400) of providing sponsored content items to a user based at least in part on an auction. At (402), method (400) can include receiving one or more auction bids associated with at least one of the sponsored content items (e.g. the sponsored content items identified in (312) of method (300)). As indicated above, the bids can be submitted by content providers associated with the relevant points of interest for which sponsored content items are identified. A bid can be indicative of an amount of money that a content provider is willing to pay for provision of their sponsored content item to a user. In example embodiments, the bid can be indicative of an amount of money the content provider is willing to pay per interaction (e.g. per click or impression) with the sponsored content item by a user. The content provider may submit different bids for different sponsored content items and/or different users.

At (404), method (400) can include determining a quality score for the sponsored content items. For instance, a quality score can be determined for each sponsored content item for which a bid was received. The quality score can be indicative of the relevance of the sponsored content item to the user, an aesthetic quality associated with the sponsored content item and/or a performance history (e.g. previous click-through and/or impression rates). In this manner, the quality score can be indicative at least in part of an expected performance of the sponsored content item when presented to the user.

At (406), method (400) can include determining an order of provision based at least in part on the received bids and the determined quality scores. The order of provision can be determined by scoring or otherwise ranking the sponsored content items based at least in part on the quality scores and the received bids. For instance, a first sponsored content item having a lower bid relative to a second sponsored content item may still be higher in the order of provision if the quality score of the first sponsored content item is high enough relative to the quality score of the second sponsored content item to offset the differences in the bids.

In example embodiments, an order of provision may be determined of multiple categories of sponsored content items. For instance, in embodiments wherein the sponsored content items are to be provided by a point of interest aggregator, an order of provision may be determined for each category of location and/or activity in which points of interest are to be grouped.

At (408), method (400) can include providing at least one sponsored content item to the user based at least in part on the order of provision. In particular, the at least one sponsored content item may be provided within a user interface associated with a point of interest aggregator, such as user interface 100 depicted in FIG. 1. For instance, the top sponsored content item (as specified by the order of provision) may be provided to the user. As another example, the top two or three sponsored content items may be provided to the user. It will be appreciated that any suitable number of sponsored content items may be provided to the user. In embodiments wherein multiple orders of provision are determined, at least one sponsored content item may be provided to the user for each order of provision. For instance, in the above example, at least one sponsored content item can be provided to the user for one or more of the categories associated with the point of interest aggregator.

FIG. 5 depicts an example computing system 500 that can be used to implement the methods and systems according to example aspects of the present disclosure. The system 500 can be implemented using a client-server architecture that includes a server 510 that communicates with one or more client devices 530 over a network 540. The system 500 can be implemented using other suitable architectures, such as a single computing device.

The system 500 includes a server 510, such as a web server. The server 510 can host a geographic information system, such as a geographic information system associated with a mapping service, and/or a point of interest aggregator. The server 510 can be implemented using any suitable computing device(s). The server 510 can have one or more processors 512 and one or more memory devices 514. The server 510 can also include a network interface used to communicate with one or more client devices 530 over the network 540. The network interface can include any suitable components for interfacing with one more networks, including for example, transmitters, receivers, ports, controllers, antennas, or other suitable components.

The one or more processors 512 can include any suitable processing device, such as a microprocessor, microcontroller, integrated circuit, logic device, or other suitable processing device. The one or more memory devices 514 can include one or more computer-readable media, including, but not limited to, non-transitory computer-readable media, RAM, ROM, hard drives, flash drives, or other memory devices. The one or more memory devices 514 can store information accessible by the one or more processors 512, including computer-readable instructions 516 that can be executed by the one or more processors 512. The instructions 516 can be any set of instructions that when executed by the one or more processors 512, cause the one or more processors 512 to perform operations. For instance, the instructions 516 can be executed by the one or more processors 512 to implement, for instance, the point of interest identifier 202, the relevance analyzer 204 and/or the auction manager 206, as described with reference to FIG. 2.

As shown in FIG. 5, the one or more memory devices 514 can also store data 518 that can be retrieved, manipulated, created, or stored by the one or more processors 512. The data 518 can include, for instance, location data, contextual data, points of interest identified according to example aspects of the present disclosure, content items, and other data. The data 518 can be stored in one or more databases. The one or more databases can be connected to the server 510 by a high bandwidth LAN or WAN, or can also be connected to server 510 through network 540. The one or more databases can be split up so that they are located in multiple locales.

The server 510 can exchange data with one or more client devices 530 over the network 540. Although two client devices 530 are illustrated in FIG. 5, any number of client devices 530 can be connected to the server 510 over the network 540. Each of the client devices 530 can be any suitable type of computing device, such as a general purpose computer, special purpose computer, laptop, desktop, mobile device, navigation system, smartphone, tablet, wearable computing device, a display with one or more processors, or other suitable computing device.

Similar to the server 510, a client device 530 can include one or more processor(s) 532 and a memory 534. The one or more processor(s) 532 can include one or more central processing units (CPUs), graphics processing units (GPUs) dedicated to efficiently rendering images or performing other specialized calculations, and/or other processing devices. The memory 534 can include one or more computer-readable media and can store information accessible by the one or more processors 532, including instructions 536 that can be executed by the one or more processors 532 and data 538. For instance, the memory 534 can store instructions 536 for implementing a user interface module for displaying points of interest and/or sponsored content items determined according to example aspects of the present disclosure.

The client device 530 of FIG. 5 can include various input/output devices for providing and receiving information from a user, such as a touch screen, touch pad, data entry keys, speakers, and/or a microphone suitable for voice recognition. For instance, the client device 530 can have a display device 535 for presenting a user interface displaying points of interest and/or sponsored content items according to example aspects of the present disclosure.

The client device 530 can also include a network interface used to communicate with one or more remote computing devices (e.g. server 510) over the network 540. The network interface can include any suitable components for interfacing with one more networks, including for example, transmitters, receivers, ports, controllers, antennas, or other suitable components.

The network 540 can be any type of communications network, such as a local area network (e.g. intranet), wide area network (e.g. Internet), cellular network, or some combination thereof. The network 540 can also include a direct connection between a client device 530 and the server 510. In general, communication between the server 510 and a client device 530 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of providing content to a user within a point of interest aggregator, the method comprising:
providing for display, by one or more computing devices, a user interface associated with a point of interest aggregator, the point of interest aggregator being configured to provide to a user information associated with a region of interest;
receiving, by the one or more computing devices, first contextual data associated with a region of interest, the first contextual data associated with one or more locations within the region of interest;
identifying, by the one or more computing devices, a plurality of points of interests within the region of interest based at least in part on the first contextual data;
receiving, by the one or more computing devices, second contextual data associated with user;
identifying, by the one or more computing devices, one or more relevant points of interest from the plurality of points of interest based at least in part on the second contextual data;
identifying, by the one or more computing devices, one or more sponsored content items, each sponsored content item providing information associated with a relevant point of interest; and
providing, by the one or more computing devices, at least one of the one or more identified sponsored content items within the user interface associated with the point of interest aggregator.

2. The computer-implemented method of claim 1, wherein the first contextual data associated with the region of interest comprises data relating to at least one of user reviews associated with the one or more locations, activities that can be performed at the one or more locations, social media activity associated with the one or more locations, proximity of the one or more locations to the current location of the user, or weather proximate the one or more locations.

3. The computer-implemented method of claim 2, wherein the first contextual data associated with the region of interest comprises temporal data relating to at least one of a time of day, a day of the week, or a season of the year.

4. The computer-implemented method of claim 1, wherein the second contextual data associated with the user comprises data relating to one or more interests of the user.

5. The computer-implemented method of claim 4, wherein the second contextual data associated with the user comprises temporal data, location data, or weather data associated with the user.

6. The computer-implemented method of claim 1, wherein the one or more sponsored content items comprise one or more advertisements associated with the region of interest.

7. The computer-implemented method of claim 1, wherein providing, by the one or more computing devices, at least one of the one or more identified sponsored content items to the user comprises:
receiving, by the one or more computing devices, one or more bids from one or more content providers associated with the one or more relevant sponsored content items;
determining, by the one or more computing devices, a quality score associated with each of the relevant sponsored content items for which bids are received;
determining, by the one or more computing devices, an order of provision associated with the relevant sponsored content items for which bids are received based at least in part on the received bids and the determined quality scores; and
providing, by the one or more computing devices, at least one of the one or more sponsored content items to the user based at least in part on the order of provision.

8. The computer-implemented method of claim 7, wherein the received bids are indicative of an amount of money that the respective content providers are willing to pay for provision of the sponsored content items to the user.

9. The computer-implemented method of claim 7, wherein the quality score is determined based at least in part on the second contextual data associated with the user and a previous performance of the respective sponsored content items.

10. The computer-implemented method of claim 9, wherein the previous performance is determined based at least in part on a previous click-through rate associated with the respective sponsored content items.

11. The computer-implemented method of claim 1, further comprising providing for display, by the one or more computing devices, one or more non-sponsored content items within the user interface associated with the point of interest aggregator in addition to the one or more sponsored content items, each non-sponsored content item providing information associated with a relevant point of interest.

12. A computing system, comprising:
one or more processors; and
one or more memory devices, the one or more memory devices storing computer-readable instructions that when executed by the one or more processors cause the one or more processors to perform operations, the operations comprising:
providing for display a user interface associated with a point of interest aggregator, the point of interest aggregator being configured to provide to a user information associated with a region of interest;
receiving first contextual data associated with a region of interest, the first contextual data associated with one or more locations within the region of interest;
identifying a plurality of points of interests within the region of interest based at least in part on the first contextual data;
receiving second contextual data associated with user;
identifying one or more relevant points of interest from the plurality of points of interest based at least in part on the second contextual data;
identifying one or more sponsored content items associated with the one or more relevant points of interest; and
providing at least one of the one or more identified sponsored content items within the user interface associated with the point of interest aggregator.

13. The computing system of claim 12, wherein the first contextual data associated with the region of interest comprises data relating to at least one of user reviews associated with the one or more locations, activities that can be performed at the one or more locations, social media activity associated with the one or more locations, proximity of the one or more locations to the current location of the user, or weather proximate the one or more locations.

14. The computing system of claim 12, wherein the second contextual data associated with the user comprises data relating to one or more interests of the user.

15. The computing system of claim 13, wherein the second contextual data associated with the user comprises temporal data, location data, or weather data associated with the user.

16. The computing system of claim 12, wherein providing at least one of the one or more identified sponsored content items to the user comprises:
receiving one or more bids from one or more content providers associated with the one or more relevant sponsored content items;
determining a quality score associated with each of the relevant sponsored content items for which bids are received;
determining an order of provision associated with the relevant sponsored content items for which bids are received based at least in part on the received bids and the determined quality scores; and
providing at least one of the one or more sponsored content items to the user based at least in part on the order of provision.

17. The computing system of claim 16, wherein the quality score is determined based at least in part on the second contextual data associated with the user and a previous performance of the respective sponsored content items.

18. One or more tangible, non-transitory computer-readable media storing computer-readable instructions that when executed by one or more processors cause the one or more processors to perform operations, the operations comprising:
providing for display a user interface associated with a point of interest aggregator, the point of interest aggregator being configured to provide to a user information associated with a region of interest;
receiving first contextual data associated with a region of interest, the first contextual data associated with one or more locations within the region of interest;
identifying a plurality of points of interests within the region of interest based at least in part on the first contextual data;
receiving second contextual data associated with user;
identifying one or more relevant points of interest from the plurality of points of interest based at least in part on the second contextual data;
identifying one or more sponsored content items associated with the one or more relevant points of interest; and
providing at least one of the one or more identified sponsored content items within the user interface associated with the point of interest aggregator.

19. The one or more tangible, non-transitory computer-readable media of claim 18, wherein the first contextual data associated with the region of interest comprises data relating to at least one of user reviews associated with the one or more locations, activities that can be performed at the one or more locations, social media activity associated with the one or more locations, proximity of the one or more locations to the current location of the user, or weather proximate the one or more locations.

20. The one or more tangible, non-transitory computer-readable media of claim 18, wherein providing at least one of the one or more identified sponsored content items to the user comprises:
receiving one or more bids from one or more content providers associated with the one or more relevant sponsored content items;
determining a quality score associated with each of the relevant sponsored content items for which bids are received;
determining an order of provision associated with the relevant sponsored content items for which bids are received based at least in part on the received bids and the determined quality scores; and
providing at least one of the one or more sponsored content items to the user based at least in part on the order of provision.
